(19) United States
(12) Patent Application Publication
(10) Pub. No.: US 2005/0071299 A1
(43) Pub. Date: Mar. 31, 2005

(54) Method of assisting price determination of fuel for electricity generation and apparatus therefor

(76) Inventors: Takamasa Kiyono, Misato (JP); Masaki Suzuki, Hitachi (JP)

Correspondence Address: DICKSTEIN SHAPIRO MORIN & OSHINSKY LLP;Mark J. Thronson, 2101 L Street NW, Washington, DC, 20037-1526, US

(21) Appl. No.: 10/942,797

(22) Filed: Sep. 17, 2004

(30) Foreign Application Priority Data
Sep. 26, 2003 (JP) 2003-334801

(51) Int. Cl. G06F 17/60

(52) U.S. Cl. 705/412; 705/400

(57) ABSTRACT

A memory unit stores selling electricity income data; profit data from the selling electricity, electricity generation cost at power plant, domestic carrying-in cost from the discharge at a discharge port to the carrying-in the power plant, importation cost from the shipping port of the producing country to the discharge port, and producing country carrying-out cost data from exploitation of the fuel through an oil refinery to the carrying-out to the discharge port. A calculation unit calculates a netback whole value of the fuel by subtracting an amount of profit data and an amount of electricity generation cost from an amount of the selling electricity income data.

### CLAIM OF PRIORITY

The present application claims priority from the Japanese application serial No. 2003-334801, filed on Sep. 26, 2003, the content of which is hereby incorporated by reference into this application.

### FIELD OF THE INVENTION

The present invention relates to a technology for assisting price determination of fuel for electricity generation.

### PRIOR ART

The patent publication Japanese Patent Laid-open 2003-6374 discloses a technology for alleviating risks of a price fluctuation of fuel for electricity generation enterprise, while a constant electricity rate is set for a predetermined period for electricity customers.

It has been possible for enterprises (electricity generation enterprises) other than electricity power companies to sell electricity generated by the enterprise to customers of electricity since 2000 in Japan. Japan largely depends on importation of fuel for electricity generation, except by-products produced in the course of petroleum product production and a part of biomass fuels. Particularly, prices of LNG and heavy oil are unstable because international market conditions determine them regardless of domestic demands. The instability of the prices is a factor for making unstable the business of both customers of electricity and fuel suppliers who supply fuel to the electricity generation enterprises. Accordingly, it is preferable that the price of the fuel for electricity generation is determined within a range of a price at which the electricity generation enterprises can purchase continuously from the fuel suppliers. Such the price should be acceptable and reasonable for both the electricity generation enterprise and the fuel suppliers. The technology disclosed in the above-mentioned Japanese Patent Laid-open simply sets a constant electricity rate for the electricity customers within a predetermined period, but does not assist price determination of the fuel.

### SUMMARY OF THE INVENTION

The present invention was conceived based on the above-mentioned background, and an object of the present invention is to propose a price, which is satisfactorily acceptable both to electricity generation enterprises and the fuel suppliers.

In order to achieve the above-mentioned object, the present invention provides a method of assisting determination of a fuel price by calculating and outputting a netback price of the fuel using a computer system.

For example, there are memorized in a memory device of the computer system a selling electricity income data in a selling electricity income from selling electricity using the fuel by the electricity generation enterprise, a profit data in a profit using the fuel by the electricity generation enterprise, an electricity generation cost data in a cost required for electricity generation using the fuel carried into the power generation plant by the electricity generation enterprise, a domestic carrying-in cost data in a cost required during the discharge of the fuel at a discharge port through carrying of the fuel into the power generation plant, an importation cost data in an importation cost during the carrying-out of the fuel from a producing country to the discharge port, and a producing country cost data in a cost required during the exploitation of the raw fuel material through a refinery to the shipping port.

A computation device of the computer system carries out a netback whole value calculation step for calculating a netback whole value of the fuel by subtracting an amount represented by the profit data and an amount of an electricity generation cost data memorized in the memory device, a netback price calculation step for calculating a netback price of the fuel by subtracting an importation cost data value and the producing country carrying-out cost data value memorized in the memory device from the netback whole value of the fuel, and a netback outputting step for outputting the netback price on the output device of the computer system.

According to the present invention, wherein the netback price, which is linked to an income from selling electricity by the electricity generation enterprise, i.e. electricity rate, is calculated and output, it is possible to propose a price of fuel for electricity generation that is stable and not affected by an international market condition and is acceptable and satisfactory to both the electricity generation enterprise and fuel suppliers.

### BRIEF DESCRIPTION OF THE DRAWINGS

FIG. 1 shows a diagrammatic view of a system for assisting fuel price determination to which an embodiment of the present invention is applied.

FIG. 2 is a diagrammatic view of the assisting apparatus 1 for fuel price determination.

FIG. 3 shows a hardware constitution of the assisting apparatus 1 for fuel price determination.

FIG. 4 shows an operation flow chart for the assisting apparatus 1 for fuel price determination.

### DETAILED DESCRIPTION OF THE PREFERRED EMBODIMENTS

In the following, the embodiments of the present invention will be described by reference to the drawings.

In the embodiment, the electricity generation enterprise has a power plant, conducts electricity generation at the plant using a fuel (heavy oil or LNG), purchased from the fuel suppliers, and supplies electricity to customers of electricity. The fuel suppliers and/or related enterprises have fuel refining factories or refineries of raw material or clued oil in producing countries, exploit raw material in exploitation sites (oil wells, gas wells. etc), refine the raw material at the refining factories, ship and export the refined fuel from shipping ports to countries of the customers, and discharge and carry the fuel into the power plant of the electricity generation enterprise. The fuel price determination assisting apparatus of this embodiment is used for assisting the price determination of the fuel for electricity generation, which is supplied through the above-mentioned routes to the electricity generation enterprise.

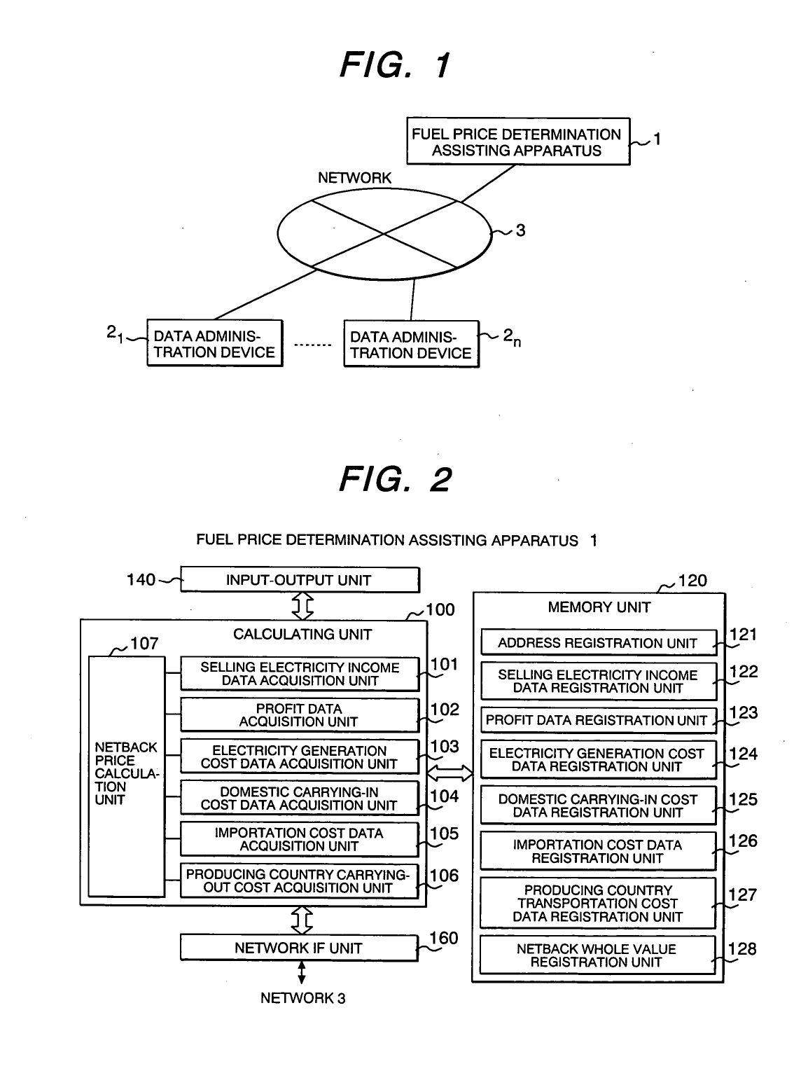

FIG. 1 shows a diagrammatic view of the fuel price determination assisting system to which the present invention is applied. As shown in FIG. 1, the fuel price determination assisting system of this embodiment comprises a fuel price determination assisting apparatus 1, which is connected to one or more data administration devices 2₁-2ₙ by means of a network 3 such as Internet.

The data administration devices 2₁-2ₙ keep at least one of plural data necessary to determine the fuel price by the fuel price determination assisting apparatus 1. In response to demand from the fuel price determination assisting apparatus 1, the administration device sends the kept data to the fuel price determination assisting apparatus 1. The plural kinds of data include selling electricity income data, profit data, electricity generation cost data, domestic carrying-in cost data, importation cost data, and producing country carrying-out cost data.

The selling electricity data is represents an selling electricity income acquired from the electricity customers. The selling electricity income depends on electricity rate. The profit data represents a profit, which the electricity generation enterprise want to secure from the selling electricity income. The profit is determined based on a standard profit rate in the business field of electricity generation and selling electricity income. The electricity generation cost data represents a electricity generation cost required for electricity generation using the fuel carried into the power plant by the electricity generation enterprise. The electricity generation cost includes amortization of the electricity plants, interest rates for borrowed money from financial organs, operation cost of the power plant, maintenance cost for the power plant, cost for consuming material such as cooling water, reagents, pure water, ammonia, etc, cost for drain water, cost for reserving environment, cost for purchasing backup electricity, etc. The electricity generation cost varies depending on duration of generation, an amount of generation, the number of stop and start, etc.

The domestic carrying-in cost data represents the domestic carrying-in cost required during the discharge of the fuel at the discharge port through the carrying-into the power plant. The domestic carrying-in cost includes, for example, transportation rate by a tank lorry from the discharge port to the power plants. The importation cost data represents the importation cost from the shipping port of the producing country to the discharge port. The importation cost includes transportation rate by a tanker, for example, from the shipping port to the discharge port. The producing country carrying-out cost data represents the producing country carrying-out cost required during the exploitation sites of the fuel raw material through the refining factories to the shipping ports. The producing country carrying-out cost includes exploitation cost of the raw material from the sites, the refining cost of the raw material, and a transportation rate from the refining factories to the shipping port by tank-lorries, for example.

The fuel price determination assisting apparatus 1 makes access to the data administration devices 2₁-2ₙ by means of the network 3, to acquire plural kinds of data necessary for determining the fuel price from the data administration devices 2₁-2ₙ. The price (netback price) of the fuel for electricity generation is calculated using the acquired data.

Next, the fuel price determination assisting apparatus 1 will be explained in detail. Since conventional devices such as FTP servers can be used as the data administration devices 2₁-2ₙ, the detailed explanation for them is omitted in this embodiment.

FIG. 2 shows a diagrammatic view of the fuel price determination assisting apparatus 1. As shown in FIG. 2, the fuel price determination assisting apparatus 1 has a computation unit 100, a memory unit 120, an input/output unit 140 for inputting and outputting various information, and a network IF (interface) unit 160.

The memory unit 120 comprises an address registration unit 121, an selling electricity income data registration unit 122, a profit data registration unit 123, an electricity generation cost registration unit 124, a domestic carrying-in cost data registration unit 125, an importation cost data registration unit 126, a producing country carrying-out cost data registration unit 127, and a netback whole value registration unit 128.

Address for making access to the data administration devices 2₁-2ₙ that administer the data necessary for determining the fuel price is registered in the address registration unit 121. The selling electricity income data in the past periods acquired from the data administration devices 2₁-2ₙ for administrating the selling electricity data is stored in the selling electricity income data registration unit 122. The profit data in the past periods acquired from the data administration devices 2₁-2ₙ that administer the profit data is stored in the profit data registration unit.

The electricity generation cost data in the past periods acquired from the data administration device 2₁-2ₙ for administrating the electricity generation cost data is stored in the electricity generation data registration unit 124. The domestic carrying-in cost data in the past periods acquired from the data administration devices 2₁-2ₙ for administrating the domestic carrying-in cost is stored in the domestic carrying-in cost data registration unit 125. The importation cost data in the past periods acquired from the data administration devices 2₁-2ₙ for administrating the importation cost data is stored in the importation cost data registration unit 126. The producing country carrying-out cost data in the past periods acquired from the data administration devices 2₁-2ₙ for administrating the producing country carrying-out cost data is stored in the producing country carrying-out data registration unit 127. The data administration devices 2₁-2ₙ store and keep the object data in the past periods in term of month or week, for example.

The netback whole value of the fuel is registered in the netback whole value registration unit 128. The netback whole value of the fuel in a designated period is an amount obtained by subtracting the electricity generation cost using the fuel and a profit that the electricity generation enterprise wants to secure from the selling electricity income in the respective periods, which is obtained by electricity generation at the power plant using the fuel.

Next, the computation unit 100 comprises an selling electricity income data acquisition unit 101, a profit data acquisition unit 102, an electricity generation cost data acquisition unit 103, a domestic carrying-in cost data acquisition unit 104, an importation cost data acquisition unit 105, a producing carrying-out cost data acquisition unit 106, and a netback price calculation unit 107.

The selling electricity income data acquisition unit 101 specifies the address registered in the address registration unit 121, wherein the address corresponds to the kinds in the selling electricity income data. The selling electricity income data acquisition unit 101 makes access by means of the network IF unit 160 to the data administration devices 2₁-2ₙ having the address so as to acquire the selling electricity income data. The acquired selling electricity data is stored in the selling electricity income data registration unit 122.

The profit data acquisition unit 102 specifies address registered in the address registration unit 121, wherein the address corresponds to the kinds in the profit data. The profit data acquisition unit 102 makes access to the data administration devices 2₁-2ₙ to acquire the profit data by means of the network IF unit 160.

The selling electricity cost data acquisition data unit 103 specifies the address registered in the address registration unit 121. The selling electricity cost data acquisition data unit 10 makes access by means of the network IF unit 160 to the data administration devices 2₁-2ₙ having the address so as to acquire the selling electricity data. The acquired selling electricity cost data is registered in the selling electricity cost data registration unit 124.

The domestic carrying-in cost data acquisition unit 104 specifies the address registered in the address registration unit 121, wherein the address corresponds to the kinds in the domestic carrying-in cost data. The domestic carrying-in cost data acquisition unit 104 makes access by means of the network IF unit 160 to the data administration devices 2₁-2ₙ having the address thereby to acquire the domestic carrying-in cost data. The acquired domestic cost data is registered in the domestic carrying-in cost data registration unit 125.

The importation cost data acquisition unit 105 specifies the address registered in the address registration unit 121 corresponding to the kinds in the importation cost data. The importation cost data acquisition unit 105 makes access by means of the network IF unit 160 to the data administration devices 2₁-2ₙ having the address to acquire the importation cost data. The acquired importation cost data is registered in the importation cost data registration unit 126.

The producing country cost data acquisition unit 106 specifies the address registered in the address registration unit 121 corresponding to the kinds in the producing country carrying-out cost data. The producing country cost data acquisition unit 106 makes access by means of the network IF unit 160 to the data administration devices 2₁-2ₙ to acquire the producing country carrying-out cost data. The acquired producing country carrying-out cost data is registered in the producing country carrying-out cost data registration unit 127.

The netback price calculation unit 107 calculates the netback whole value of the fuel for electricity generation in accordance with directions received from an operator through the input/output unit 140, using the data registered in the memory unit 120. The calculated netback whole value is registered in the netback whole value registration unit 128. The netback price of the fuel for electricity generation is calculated and output from the input/output unit 140.

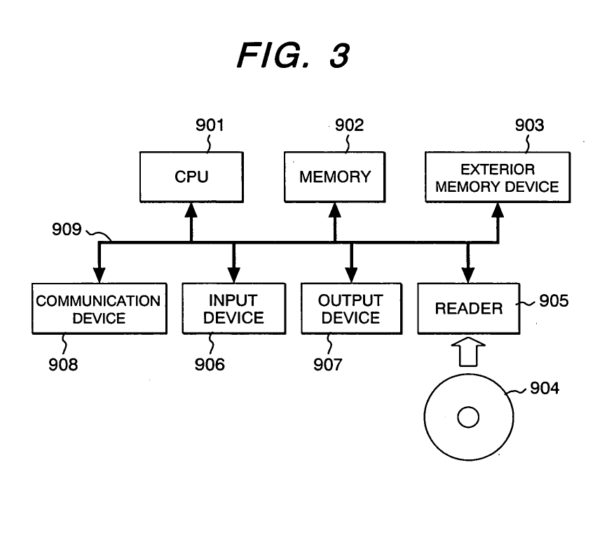

The fuel price determination assisting apparatus 1 of the embodiment can be realized wherein CPU 901 carries out the predetermined program loaded on the memory 902 in the ordinary computer system shown in FIG. 3, which comprises CPU 901, a memory 902, an exterior memory device 903 such as HDD, a reader 905 which reads out information from a portable recording medium 904 such as CD-ROM, DVD-ROM, etc, an input device 906 such as a keyboard, a mouse, etc, an output device 907 such as a display, and a communication device 908 for communicating with partner devices by means of the network.

The predetermined program is downloaded from the recording medium 904 through the reader 905 or the network through the communication device 908, and then the loaded program is loaded on the memory 902 to be executed by the CPU 904. Further, the program can be directly loaded on the memory 902 from the recording medium 904 by means of the reader 905 or from the network by means of the communication device 908, thereby to execute the program by CPU 901. In this case, the memory unit 120 is utilized by the memory 902 or the exterior memory device 903 or the recording medium 904.

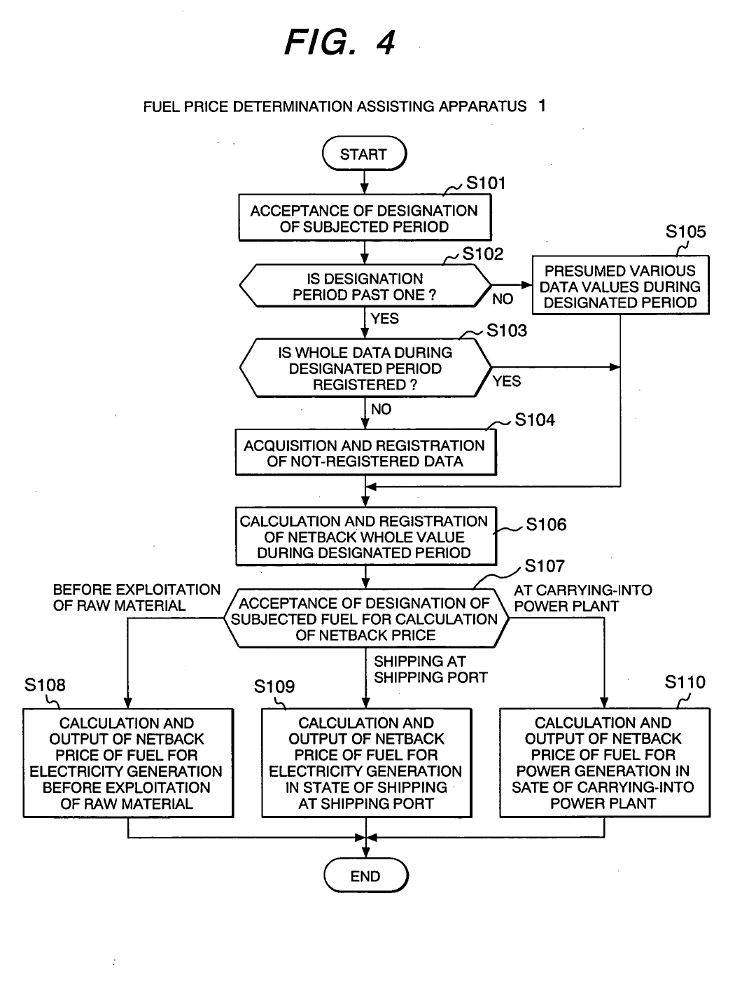

FIG. 4 shows an operation flow of the fuel price determination assisting apparatus 1. At first, the netback price calculation unit 107 accepts the designation of a period for calculating the netback price of the fuel from an operator by means of the input/output unit 140 (S101). If the designation period is past one (last month, in S101, “YES”, for example), each of the selling electricity income data registration unit 122, the profit data registration unit 123, the electricity generation cost data registration unit 124, the domestic carrying-in cost data registration unit 125, the importation cost data registration unit 126 and the producing country carrying-out cost data registration unit 127 is searched whether the data in the designated period is contained in the data in the registered past period (S103) or not. If the designated data is contained in all of the data registration units 122-127, the step goes to S106.

On the other hand, if there are the data registration units 122-127 that do not contain data in the designated periods, instruction of the data acquisition of data in the designated periods is given the data acquisition units 101-106 corresponding to the data registration units 122-127 for acquiring the registered data. The thus instructed data acquisition units 101-106 specify the address registered in the address registration unit 121, wherein the data corresponds to the kinds of the acquisition object data. The instructed data acquisition units 101-106 make access by means of the network IF unit 160 to the data administration devices 21-2, having the address to acquire the acquisition object data in the designated periods. The acquired acquisition object data is registered in the data registration units 122-127 (S104) corresponding to the data acquisition units 101-106 (S104). Then, the process goes to S106.

On the other hand, if the designated periods received from the operator is not past (this month, in S102, “NO”, for example), the netback price calculation unit 107 presumes the selling electricity income data, the profit data, electricity generation cost data, the domestic carrying-in cost data, the importation cost data and the producing country carrying-out cost data (S105). For example, if the selling electricity income data of this month (September of this year, for example) is presumed, the netback price calculation unit 107 calculates an average value by extracting the selling electricity income data of the past same months (months of September of the years before last year) from the selling electricity income data of the past respective months registered in the selling electricity income data registration unit 122, so that the calculation result is presumed as the selling electricity income of this month.

It is possible to calculate an average value of the selling electricity income data of the previous month of the same month of this year (months of August of the years before last year), and to calculate a ratio of the average value to the selling electricity income of the last same months. The selling electricity income data of the previous month (August) is multiplied by the calculated ratio, so that the multiplied result is presumed as the selling electricity income data of this month. In addition to the selling electricity income data, the profit data, the electricity generation cost data, the domestic carrying-in cost data, the importation cost data, and the producing country carrying-out cost data are also calculated in the same way.

When the selling electricity income data, the profit data, the electricity generation cost data the domestic carrying-in cost data the importation cost data and the producing country carrying-out cost data in the designated periods are presumed, the step goes to s106.

Next, in S106, the netback price calculation unit 107 calculates the netback whole value of the fuel for electricity generation in the designated periods. The calculation result is registered in the netback whole value registration unit 128. For example, the netback whole value in the designated period is calculated by subtracting the profit amount in the profit data and the netback whole value in the electricity generation cost data in the designated month from an amount of the selling electricity income data in the designated periods. If the designated period is past one, the selling electricity income data, the profit data, and the electricity generation cost data, which are all registered in the selling electricity income data registration unit 122, the profit data registration unit 123, and the electricity generation cost data registration unit 124.

On the other hand, if the designated period is no past one, the selling electricity income data, the profit data, and the electricity generation cost data presumed in the designated periods obtained at S105 are used.

Now, the netback value calculation unit 107 registers the netback whole value in the designated periods in the netback whole value registration unit 128, and then accepts designation of the fuel for electricity generation which is a basis of calculation of the netback price from the operator through the input/output unit 140 (S10). In this embodiment, as the fuel for electricity generation, which is the calculation object of the netback price, the fuel is designated from the fuel before exploitation i.e. buried state fuel, the fuel carrying-out at the shipping port, and the fuel carried in the power plant.

At S107, if the fuel before exploitation (buried resource) is designated, the netback price calculation unit 107 calculated the netback price of the fuel before exploitation in the designated period by subtracting the importation cost value in the importation cost data and the producing country carrying-out cost value in the producing country carrying-out cost data in the designated period from the netback whole value of the fuel in the designated period. The calculated netback price is outputted from the input/output unit 140 so as to present it to the operator (S108).

If the designated period is past one, the importation cost data of the designated period registered in the importation cost data registration unit 126. On the other hand, if the designated period is not past one, the importation cost data in the designated period, which is presumed at S105.

At S107, if the fuel at the time of carrying-ing-in the power plant is designated, the netback price calculation unit 107 calculates the netback price of the fuel at the time of carrying-in the power plant in the designated period by adding the electricity generation cost in the electricity generation cost data in the designated period to the netback whole value of the fuel registered in the netback whole value registration unit 128 in the designated periods. The calculated netback price is outputted from the input/output unit 140 so as to present it to the operator (S110). If the designated period is past one, the electricity generation cost data in the designated periods. On the other hand, if the designated period is not past one, the electricity generation cost data in the designated period presumed at S105.

The embodiment of the present invention has been explained. Fuel price determination assisting apparatus 1 calculates and outputs the netback price linked to the electricity rates or the selling electricity income from the electricity generation. Thus, it is possible to propose as electricity rates the prices which are acceptable to the electricity generation enterprise and the fuel suppliers and which are stable and not affected by the international market conditions.

Further, the fuel price determination assisting apparatus 1 calculates the netback price of any of the fuels in accordance with the operator, the fuels including the fuel before exploitation, the fuel at the time of carrying-out at the shipping port, and the fuel at the time of carrying-in the power plant. According to this method, it is possible to calculate the netback price of the fuel in accordance with an agreement between the electricity generation enterprise and the fuel suppliers.

The present invention is not limited to the above embodiment, but there may be various modifications within the sprit of the present invention.

For example, in the embodiment, the operator selects fuel, as the calculation object of the netback price, among the fuel before exploitation, the fuel at carrying-out from the shipping port, and the fuel at the time of carrying-ing-in the power plant, but the present invention is not limited to this example. For example, the fuel at the time of carrying-in at the discharge port may be designated as the calculation object. If the fuel at the time of carrying-in the discharge port is designated as the calculation object of the netback price, the netback whole value of the fuel, which is registered in the netback whole value registration unit 128, is outputted from the input/output unit 140.

Further, in the above embodiment, various data to be registered in the data registration units 122-127 of the memory unit 120 are acquired from the data administration devices 2₁-2ₙ by means of the network IF unit 160. However, the present invention is not limited to this embodiment. For example, the various data is read out from the recording medium such as CD-ROM, DVD-ROM, etc through the input/output unit 140, and the read out data are registered in the data registration units 122-127.

In the above embodiments, one computer system are used for one fuel price determination assisting apparatus, but plural computer systems can be used for one price determination assisting apparatus.

The present invention may be applied to assistance of price determination of fuels imported through air routes instead of sea routes and fuels not imported.

1. A method of assisting price determination of fuel for electricity generation using a computer system having a calculation device and a memory device,
wherein the memory device memorizes selling electricity income data by an electricity generation enterprise using the fuel, profit data in the profit by the enterprise using the fuel, electricity generation cost data required for electricity generation using the fuel carried into a power plant, domestic carrying-in cost data in cost required for carrying-in of the fuel from a discharge port to a power plant, importation cost data required for the carrying-out from a shipping port of a producing country to the discharge port, and producing country carrying-out cost data in a cost required for exploitation of raw material, a fuel refinery and carrying-out to the shipping port, and
wherein the calculation device carries out a step for calculating a netback whole value of the fuel by subtracting an amount in profit data and an amount in the electricity generation cost, both being memorized in the memory device, from an amount of the selling electricity income data memorized in the memory device, a step for calculating a netback price of the fuel by subtracting the amount in the importation cost and the amount in the producing country carrying-out cost data, both being memorized in the memory device, from the netback whole value of the fuel, and a step for outputting a netback price of the fuel to an output device of the computer system.

2. The method of assisting price determination of fuel for electricity generation according to claim 1,
wherein the selling electricity income data, the profit data, the electricity generation cost data, the domestic carrying-in cost data, the importation cost data, and the producing country carrying-out cost data of a period in the past are memorized in the memory device,
wherein before carrying out the netback whole value calculation step, the calculation device carries out a step for accepting designation of a calculating timing of the netback price of the fuel from an operator by means of the input device of the computer system, a step for presuming an selling electricity profit, a profit, an electricity generation cost, a domestic carrying-in cost, an importation cost, and a producing country carrying-out cost in the designated period for computation in accordance with data memorized in the memory device that includes the selling electricity income data, the profit data, the electricity generation cost data, the domestic carrying-in cost data, the importation cost data, and the producing country carrying-out cost data of the respective periods,
wherein the step for calculating the netback whole value carries out calculation of the netback whole value of the fuel at the designated period, using the presumed income from selling electricity, profit, electricity generation cost, and
wherein the netback price calculation step carries out calculation of the netback price in the designated calculation period, using the netback whole value, the presumed domestic carrying-in cost, the importation cost, and the producing country carrying-out cost.

3. The method of assisting price determination of the fuel for electricity generation according to claim 1,
wherein the calculation device further carries out acceptance of selection from an operator as the object for the calculation of the netback price among the fuel before exploitation of the raw material, the fuel at the time of carrying-out from the shipping port, and the fuel at the time of the fuel carrying-in the power plant.

4. The method of assisting determination of a price of the fuel for electricity generation according to claim 1,
wherein the computation device carries out memorizing in the memory device by inputting at least one of data from a server for administration of selling electricity income data, the profit data, the electricity generation cost data, the domestic carrying-in cost data, the importation cost, and the producing country carrying-out cost data by means of a communication device of the computer system.

5. An apparatus for fuel price determination for power generation, which comprises a memory device, a computation device and an output device,
wherein the memory device memories selling electricity income data using the fuel by a electricity generation enterprise, a profit data in a profit from electricity generation by the electricity generation enterprise, a electricity generation cost data in a cost required for electricity generation using the fuel carried into the power plant by the electricity generation enterprise, a domestic carrying-in cost data in a cost required during the discharge of the fuel at a discharge port through carrying of the fuel into the power plant, an importation cost data in an importation cost during the carrying-out of the producing country through the discharge port, and a producing country carrying-out cost data in a cost required during exploitation of the fuel raw material through the refinery of the fuel to the carrying-out to the shipping port, and
wherein the computation device carried out a netback whole value calculation processing for calculating the netback whole value by subtracting an amount of the profit data and amount of the electricity generation cost memorized in the memory device from an amount of selling electricity income data memorized in the memory device, a netback price calculation processing for calculating the netback price of the fuel by subtracting an amount in the importation cost data and an amount of producing country carrying-out cost data memorized in the memory device from the netback whole value of the fuel, and a netback price outputting processing for outputting the netback price to the output device.

6. A program readable with a computer system for supporting determination for electricity generation fuel,
wherein there are memorized in a memory device, an selling electricity income data in the selling electricity income using the fuel by a electricity generation enterprise, a profit data in a profit from electricity generation using the fuel by the electric generation enterprise, a electricity generation cost data required for electricity generation using the fuel carried-into the power plant by the enterprise, a domestic carrying-in cost data in a cost required during discharge at a discharge port through carrying of the fuel into the power plant, and a producing country carrying-out cost data in a cost required during exploitation of raw material of the fuel through a refinery to the discharge port, and
wherein the program makes the computation device carrying-out a netback whole value calculation step for calculating the netback whole of the fuel by subtracting an amount represented by a profit data and an amount represented by an electricity generation cost memorized in the memory device from an selling electricity income data memorized in the memory device, a netback price calculation step for calculation of the netback price of the fuel by subtracting an amount of an importation cost and an amount represented by a producing carrying-out cost data memorized in the memory device from a netback price value of the fuel, and a netback price outputting step for outputting the netback price of the fuel to an output device of the computer system.
